(19) United States
(12) Patent Application Publication
(10) Pub. No.: US 2008/0021720 A1
(43) Pub. Date: Jan. 24, 2008

(54) System And Method For Tracking Charitable Donations

(76) Inventor: Steven J. Glinberg, Madison, WI (US)

Correspondence Address: BOYLE FREDRICKSON S.C., 840 North Plankinton Avenue, MILWAUKEE, WI, 53203, US

(21) Appl. No.: 11/779,877

(22) Filed: Jul. 18, 2007

Related U.S. Application Data
(60) Provisional application No. 60/807,667, filed on Jul. 18, 2006.

(51) Int. Cl. G06F 17/40; G06F 17/30; G06Q 10/00

(52) U.S. Cl. 705/1

(57) ABSTRACT

A system and method for allowing individuals to track their personal quantitative measure of success at causing donations to be made to charitable organizations. Under this system, the total dollar amount of all donations made by an individual, summed with all donations made by those donors who this individual personally encouraged to make a donation, summed with the donations made by donors who were indirectly encouraged by the individual (encouraged by someone else who was directly or indirectly encouraged by the individual) to make a donation, represents a score, or quantitative measure of the level of success, that the individual has attained in their effort to cause donations to be made to charitable organizations. The invention can be implemented as a system for facilitating and tracking donations, and reporting via the Internet and other media, this quantitative measure of success at causing donations to be made to charitable organizations that an individual has attained over their lifetime.

### CROSS REFERENCE TO RELATED APPLICATIONS

This application claims the benefit of U.S. provisional application Ser. No. 60/807,667 filed Jul. 18, 2006.

### BACKGROUND AND SUMMARY OF THE INVENTION

This invention relates generally to fundraising. More specifically, this invention relates to a system and method of tracking charitable donations over a wide area network, such as the Internet, in an effort to encourage donations to charitable organizations.

Non-profit fund raising efforts today have limited effectiveness due largely to a lack of feedback provided to those involved in the solicitation of donations. Teams of solicitors are often formed in an effort to motivate others through various mechanisms including inter-team competition, wherein the success of a team is calculated by summing the donations raised by the individual team members and then reported back to the team members. Fundraising efforts generally center around a single cause, and are limited to the period of time leading up to a particular campaign deadline or goal.

The method according to a preferred embodiment of the present invention transcends fundraising causes and campaigns, fostering a lifelong commitment by individuals and organizations to raise funds for non-profit entities, by providing them with a mechanism through which they can receive feedback about the success of their fundraising efforts over a lifetime.

Non-profit fund raising efforts today also have limited effectiveness due to a lack of feedback provided to those involved in the recruitment of solicitors. While much less effort appears to be focused on the recruitment of solicitors, teams are often formed in an effort to motivate recruiters and solicitors raise greater funds through mechanisms including inter-team competitions. In such a competition, the success of a team is calculated by summing the donations raised by the individual team members and then reported back to the team members. Recruitment efforts, too, generally center around a single cause, and are limited to the period of time leading up to a particular campaign deadline or goal.

The method according to one aspect of the present invention further provides individuals and organizations involved in recruitment efforts with a mechanism through which they can receive feedback about the success of their recruitment efforts over a lifetime. School children, for example, may not have the financial wherewithal to make donations themselves; however they have a tremendous amount of energy and time to offer, which can be put to use soliciting donations. This is a common practice as school children, either as individuals or as part of teams, often compete in fundraising efforts. School children often receive feedback about the total funds they raise for a given cause or for a given period of time. However, a mechanism does not exist to provide school children with adequate feedback about their success at soliciting donations to multiple causes throughout their lives, or their success in encouraging other people to work as recruiters or solicitors.

If a single school child successfully encourages three people to join them in encouraging donations to non-profit organizations, and then if each of those three people do the same, recruiting three more people each, and if this cycle repeats several times over with each generation repeating the success of the previous generation, then this creates a hierarchy of solicitors and donors, and the single school child at the top of the hierarchy who began the effort can be credited for a donation made weeks, months, or even years later by somebody lower in the hierarchy that they have never met, to a non-profit organization they have never heard of. This is also true for each person in the hierarchy between the single school child at the top who initiated the cycle and the lowest person in the hierarchy who made the final donation. The present invention will provide this single school child, and every person below him or her hierarchically, with an ever-growing real-time score that reflects their lifetime success at soliciting donations to non-profit organizations and their lifetime success at recruiting others to join them in soliciting donations to non-profit organizations. The usefulness of the present invention is of course not limited to school children or to any one group of people.

It is therefore an object of the present invention to provide individuals with a quantitative measure of their success at causing donations to be made to charitable organizations, thereby motivating them to persist in their effort to encourage donations to be made. The total dollar amount of all donations made by an individual, summed with all donations made by those donors who this individual personally encouraged to make a donation, summed with the donations made by donors who were indirectly encouraged by the individual (encouraged by someone else who was directly or indirectly encouraged by the individual) to make a donation, represents a quantitative measure of the level of success that the individual has attained in their effort to cause donations to be made to charitable organizations. The invention can be implemented as a system for facilitating and tracking donations, and reporting via the Internet and other media, this quantitative measure of success at causing donations to be made to charitable organizations that an individual has attained over his/her lifetime.

In accordance with one aspect of the present invention, a system is provided for tracking the success of an individual in causing donations to be made to charitable organizations. The system comprises a list having the name of at least one organization, a list of registered donors arranged in a hierarchy such that each donor descends from an associated solicitor. The system also includes a means for registering new donors including means for selecting an already registered donor as a solicitor, a means for recording donations, and a means for scoring an individual donor. Preferably, the score is calculated by summing the value of donations made by that donor with the value of donations made by all donors in the hierarchy that descend from the individual donor. In accordance with another aspect of the present invention, a method is provided for tracking the success of an individual in causing donations to be made to charitable organizations.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 illustrates an exemplary web page that allows a charitable organization to be added to a database in accordance with one embodiment of the present invention;

FIG. 2 illustrates an exemplary donor registration web page in accordance with one embodiment of the present invention;

FIG. 3 illustrates an exemplary web page for making a charitable donation in accordance with one embodiment of the present invention;

FIG. 4 illustrates an exemplary web page for recording a charitable donation in accordance with one embodiment of the present invention;

FIG. 5 illustrates an exemplary personal donor web page in accordance with one embodiment of the present invention;

FIG. 6 illustrates an exemplary web page that allows a third party to locate registered donors in accordance with one embodiment of the present invention;

FIG. 7 illustrates an exemplary web page that displays the results of the search of FIG. 6 in accordance with one embodiment of the present invention;

FIG. 8 is a database table of hypothetical donation data in accordance with one embodiment of the present invention;

FIG. 9 is a graphical representation of the hierarchy represented by the database table of FIG. 8;

FIG. 10 is the database table illustrated in FIG. 8 with an additional hypothetical donation;

FIG. 11 shows the hierarchy that is represented by the hypothetical donation data illustrated in FIG. 10;

FIG. 12 is a subset of the database table illustrated in FIG. 10; and

FIG. 13 shows the four steps required to create the hierarchy represented by the subset database table in FIG. 12.

### DETAILED DESCRIPTION OF PREFERRED EMBODIMENTS OF THE INVENTION

In a preferred embodiment of the invention, one or more websites are created to (1) capture information about charitable organizations to which donations may be made, (2) capture information about individuals who wish to track their success at causing donations to be made to charitable organizations, (3) facilitate and record monetary donations to charitable organizations, and (4) report the quantitative measure of each individual's success at causing donations to be made to charitable organizations. Appropriate database tables may be created to store a list of charitable organizations to which donations may be made, to store information about individuals who wish to track their success at causing donations to be made to charitable organizations, and to store information about monetary donations made to charitable organizations.

A website generally takes the form of a collection of Web content such as Web pages formatted in HTML (Hypertext Markup Language), image files, and other documents downloadable and viewable on the World Wide Web by a Web browser such as Netscape Navigator and Microsoft's Internet Explorer. A Web server is an Internet connected computer dedicated to managing Web content and making it available for viewing by Web browsers. Some Web pages contain Web links or hyperlinks which when clicked navigate the user to a different Web page. Some Web pages contain forms that may be filled in and then submitted for processing by the Web server and storage in a database. Some Web pages are comprised of various pieces of content and images which reside on different Web servers but are presented as one unified Web page.

A database is a collection of information organized in such a way that a computer program can select desired pieces of data. A database is usually organized into fields, records, and tables. A field is a single piece of information describing an attribute of an entity; a record is one complete set of fields that together fully describe an entity; and a table is a collection of records.

A Web service is a standardized way of integrating Web-based programs using XML, SOAP, WSDL, UDDI, and other standards over the Internet. To use a Web service, a request is made by a program running on an Internet connected computer, and sent over the Internet to a Web server. The Web server receives, processes and responds to the request, returning data to the requesting program. Request and response data is often formatted according to the XML standard, SOAP is used to transfer the data, WSDL is used for describing the services available and UDDI is used for listing what services are available. Web services allow organizations to share data without intimate knowledge of each other's underlying database. Web services need not provide the user with a graphical user interface, and instead expose data through a programmatic interface to external programs across a network. Programmers can incorporate the use of a Web service into a program that has a graphical user interface such as a Web page or an executable computer program.

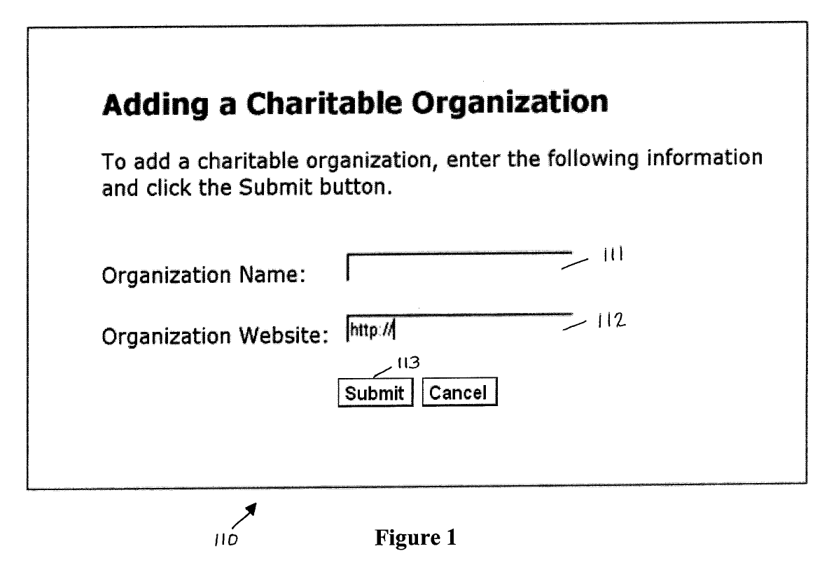

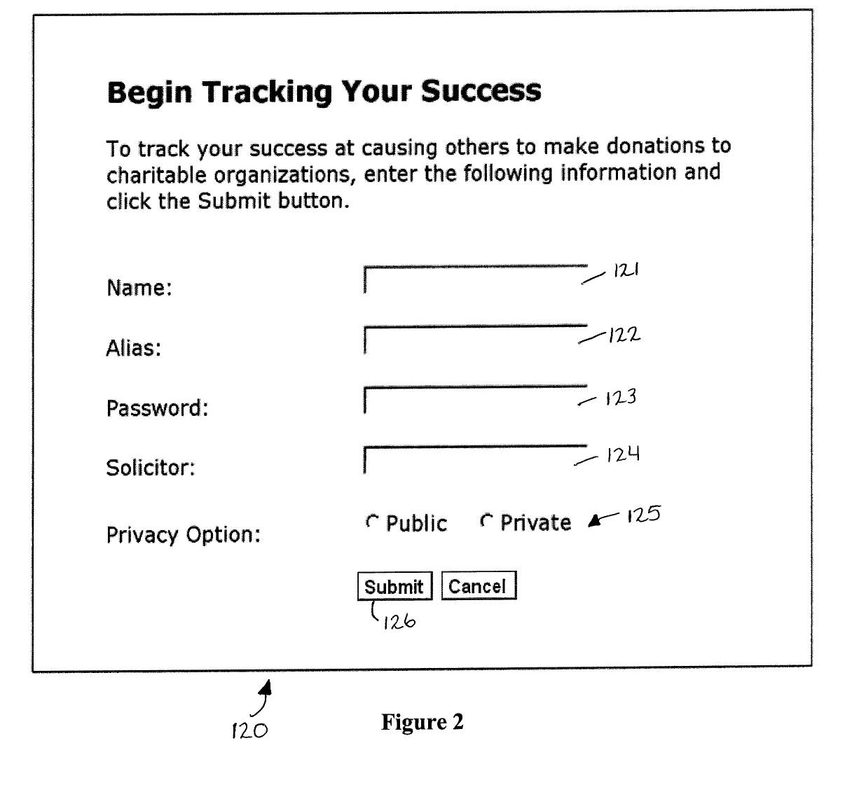

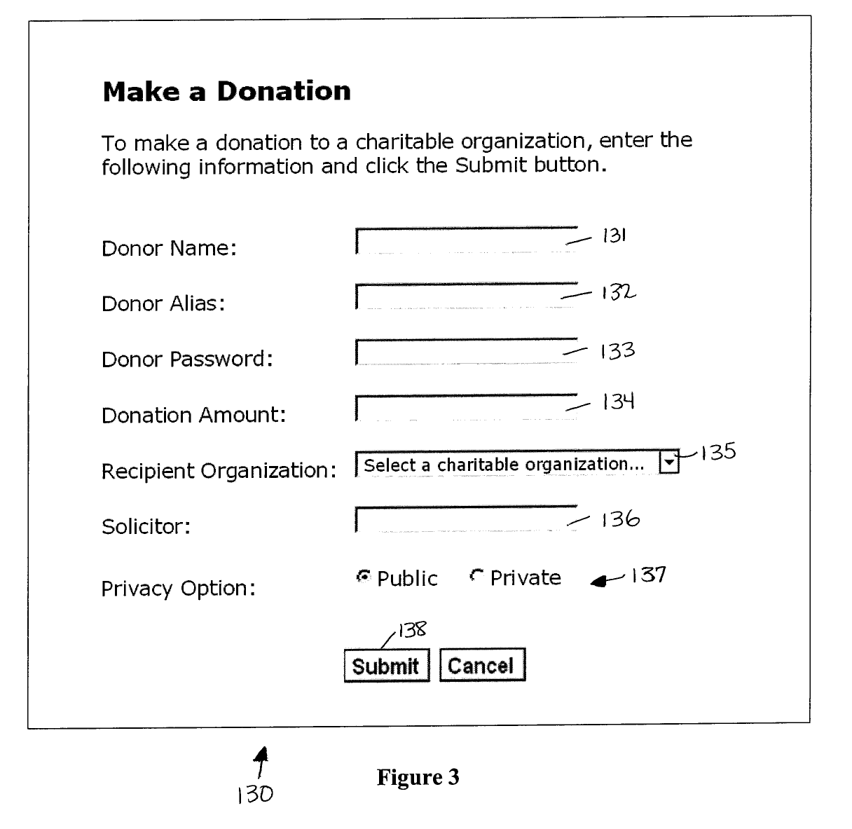

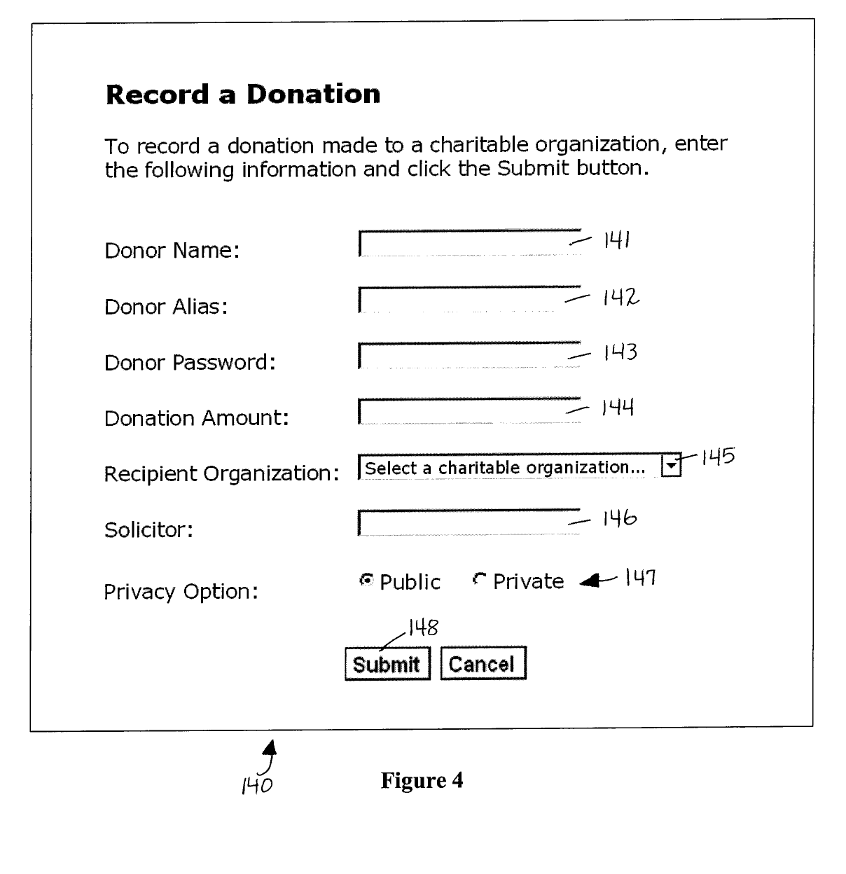

FIG. 1 shows a simplified example of a Web page form 110 designed to allow a user to submit information about a charitable organization to be added to a list of charitable organizations recorded in the database. FIG. 2 shows a simplified example of a Web page form 120 designed to allow a user to submit information about an individual who wishes to track their success at causing donations to be made to charitable organizations. FIG. 3 shows a simplified example of a Web page form 130 designed to allow a user to make a donation of money to be added to a list of all donations recorded in the database. FIG. 4 shows a simplified example of a Web page form 140 designed to allow a user to submit information about a donation of money made to a charitable organization to be added to a list of all donations recorded in the database.

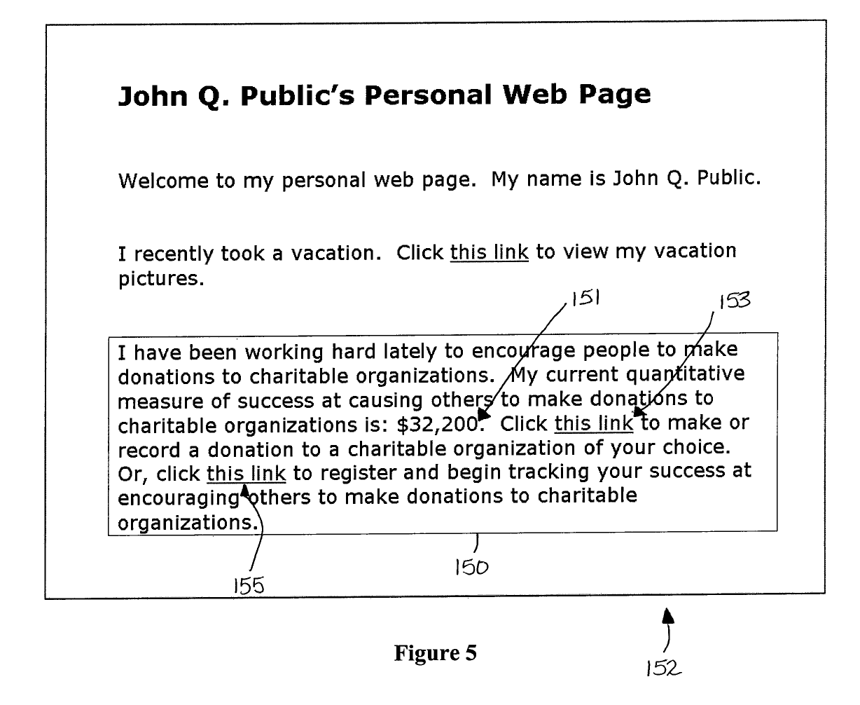

FIG. 5 shows a simplified example of a section 150 of Web content embedded in an individual's personal Web page 152, designed to report the quantitative measure of success at causing donations to be made to charitable organizations that this individual has attained, and to provide a mechanism for others to begin tracking their success at causing donations to be made to charitable organizations or to make or record a donation to a charitable organization. This is an example of a Web page that contains sections of content and images that reside on different Web servers and are presented as one unified Web page. The section of Web content embedded into an individual's personal Web page may be downloaded from the Web server that embodies the invention, while the remaining Web content that comprises the individual's personal Web page 152 may be downloaded from a different Web server. Despite this, the entire Web page will appear to a person viewing it in a Web browser as one unified Web page. Further, this section 150 of embeddable Web content may be embedded in an HTML based email message.

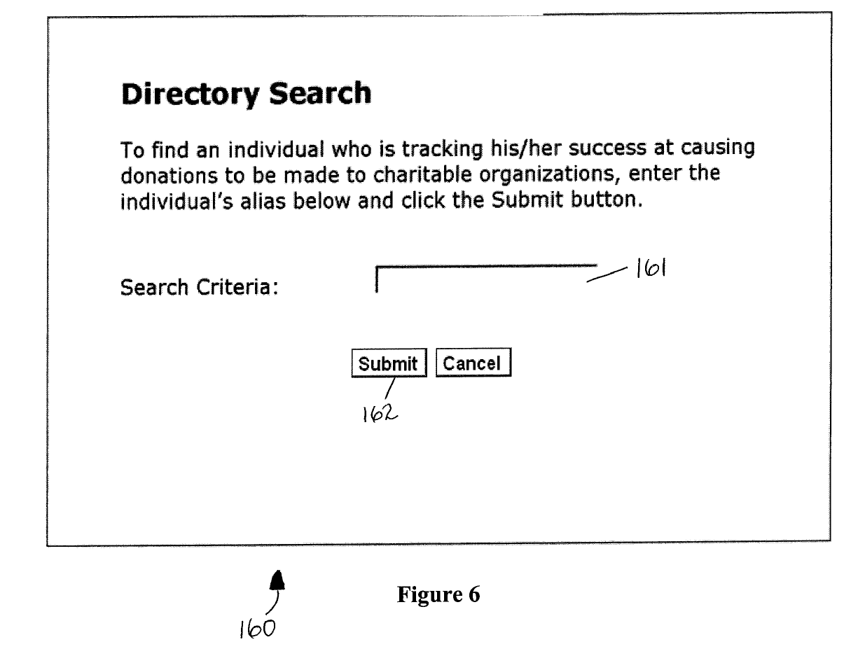

FIG. 6 shows a simplified example of a Web page 160 designed to allow a user to search a directory of individuals who have registered to track their success at causing donations to be made to charitable organizations. Although it is preferred for privacy reasons that an individual's alias may be used as a search criterion, other information may be used as search criteria.

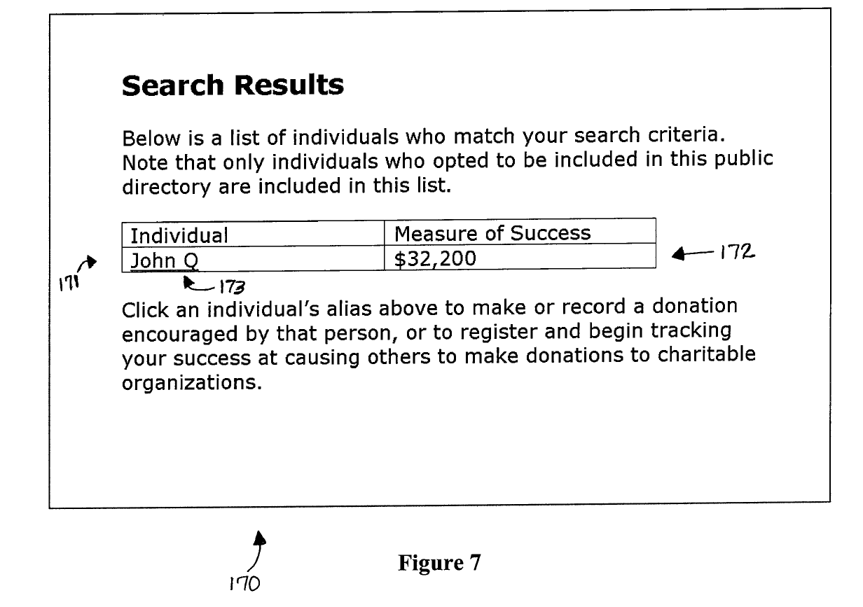

FIG. 7 shows a simplified example of a Web page 170 designed to show the result of a search of the directory of individuals who have registered to track their success at causing donations to be made to charitable organizations. The result of the search preferably includes the quantitative measure of success at causing donations to be made to charitable organizations that each individual has attained, as well as one or more Web links that can be clicked, providing a mechanism for others to begin tracking their success at causing donations to be made to charitable organizations or to make or record a donation to a charitable organization. Although it is not preferred for privacy reasons, the results of the search may also include other information about the individuals that match the search criteria, such as contact information or anything else stored in the database.

Table 1 is an example of potential fields that comprise a Charitable Organizations Table designed to record a list of charitable organizations to which donations may be made.

TABLE 1
Charitable Organization Table

| Field Name | Field Description |
|---|---|
| Organization | At the time that the organization is added to the table, a |
| Identifier | unique identifier is assigned to the organization for use in |
| | referring to the organization within the system. |
| Organization | The name of the organization. |
| Name | |
| Organization | This URL (uniform resource locator) that represents the |
| Website | organization's official website. |

Table 2 shows a simplified example of the fields that comprise a Donation Table designed to record a list of donations made to charitable organizations and a list of individuals who wish to track their success at causing donations to be made to charitable organizations.

TABLE 2
Donation Table

| Field Name | Field Description |
|---|---|
| Donation | At the time that the donation is added to the table, a unique |
| Identifier | identifier is assigned to the donation for use in referring to |
| | the donation within the system. |
| Donation | At the time that the donation is added to the table, a left |
| Left | position is assigned to the donation to aid in positioning |
| Position | the donation hierarchically beneath the donor that |
| | encouraged the donation. |
| Donation | At the time that the donation is added to the table, a right |
| Right | position is assigned to the donation to aid in positioning |
| Position | the donation hierarchically beneath the donor that |
| | encouraged the donation. |
| Donor Name | The name of the donor. |
| Donor Alias | An alias that may be used to represent the donor. |
| Donor | An indication of whether this donor wishes to be included |
| Privacy | in a publicly searchable directory of individuals tracking |
| Option | their success at causing donations to be made to charitable |
| | organizations. |
| Donation | An indication of whether this donation is a monetary |
| Type | donation, or the donation of time. |
| Donation | The dollar amount of the donation if it is a monetary |
| Amount | donation. |
| Donation | The date and time that the donation was made. |
| Date | |
| and Time | |
| Organization | The identifier of the recipient organization if it is a |
| Identifier | monetary donation. |

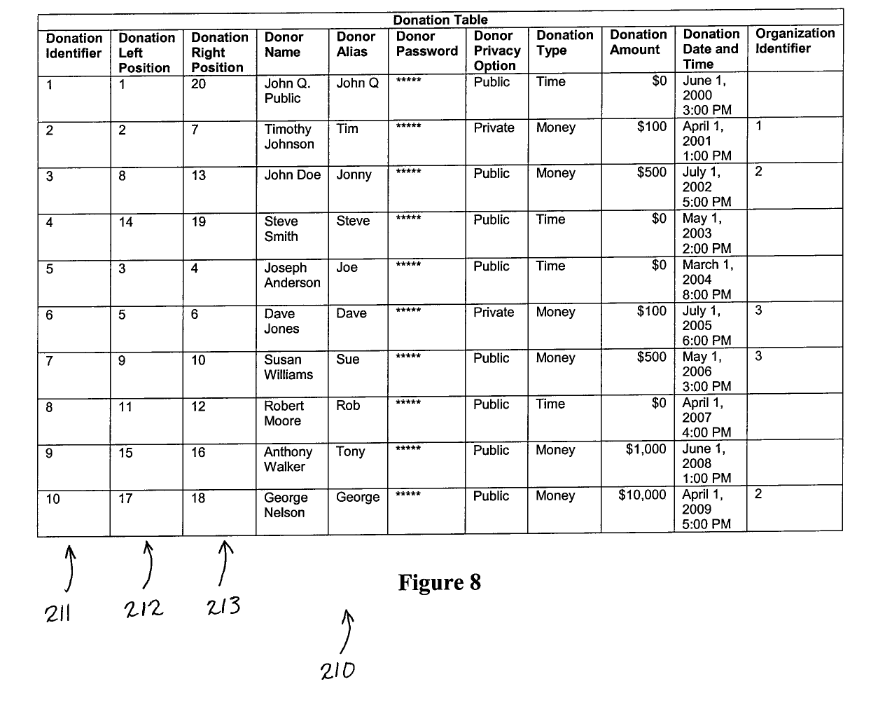

Although the depicted embodiment of the invention uses a specific embodiment of a system to represent a hierarchical structure using records in a table, a different embodiment of a system could be used to achieve the same end. Specifically referring to FIGS. 8-13, the system according to one embodiment of the invention requires the assignment of two numbers to each node 20 in the hierarchy; a left and right number (designated as L: and R:). These numbers are then stored as fields 212, 213 of a record in a database table 210 along with other fields that together fully describe a single donation node 20 in the hierarchy 30. To begin, the numbers 1 and 2 are assigned to the first, upper-most, node 22 in the hierarchy 30. Each time a new node 20 is subsequently added to the hierarchy 30 it is added immediately beneath an existing node, referred to as the parent node, and to the right of any other nodes beneath the same parent node, referred to as sibling nodes. The new node 20 is then assigned a left and right number according to the following two rules: 1) the new node's left number is larger than the parent node's left number and larger than any siblings' right number; 2) the new node's right number is larger than the new node's left number and smaller than the parent node's right number. A couple of mechanisms may be used to avoid running out of numbers: decimals may be used to create infinite capacity for new nodes, or alternatively the numbers assigned to existing nodes may be shifted to make room for the new node.

FIG. 13 shows the creation of a hierarchy in four steps using this system. At step I, a first donor 40, such as a charitable organization, is entered into a database table and given the left number of 1 and right number of 2. In step II, the first donor 40 has caused a second donor 41 to be added to the database table. The right number of the first number is adjusted upwards by two to accommodate the second donor 41. In step II, the first donor 40 has caused a third donor 42 to be added to the database table. The right number of the first donor 40 is adjusted upwards by two. The left and right numbers for the second donor 41 do not change. In step IV, the second donor 41 has caused a fourth donor, or node in the hierarchy, 43 to be added to the database table. The right number of the second donor 41 is increased by two to accommodate the fourth donor 43. The left and right numbers for the third donor 42 as well as the right number for the first donor 40 are also increased to accommodate the fourth donor 43.

An individual may use the invention to track his/her personal score, i.e., the quantitative measure of success at causing donations to be made to charitable organizations or the individual may be an authorized representative of a business entity and may use the invention to track that entity's quantitative measure of success at causing donations to be made to charitable organizations.

As used herein, the term “score” is defined as: the total dollar amount of all donations made by an individual, summed with all donations made by those donors who this individual personally encouraged to make a donation, summed with the donations made by donors who were indirectly encouraged by the individual (encouraged by someone else who was directly or indirectly encouraged by the individual) to make a donation, and represents a quantitative measure of the level of success over their lifetime that the individual has attained in their effort to cause donations to be made to charitable organizations.

The term “individual” may be a person or organization acting on behalf of themselves, on behalf of someone else, or on behalf of an organization including corporate or non-corporate entities.

The terms “donor” and “solicitor” are synonymous in the context of the preferred embodiment of the present invention. From the perspective of the hierarchy, the two are treated the same, so that, for example, a solicitor who does not himself make a donation still has a score that is the sum of all donations that fall behind him in the hierarchy. Furthermore, an individual may be considered a donor once registered regardless of whether they made a contribution or not.

To illustrate how an embodiment of the invention might be used, the following non-limiting examples are presented to illustrate various features of significance. The examples are intended merely to facilitate an understanding of ways in which the present invention may be practiced and to further enable those of skill in the art to practice the present invention. Accordingly, the examples should not be construed as limiting the scope of the present invention.

A Charitable Organization table, such as that shown in Table 1, is initialized with a list of popular charitable organizations. This may be done by a website administrator who browses to a website that embodies the invention and chooses to add a charitable organization to the database. The website administrator is presented with a Web page form similar to the one shown in FIG. 1. An organization name is entered into the Organization Name field 111 and that organization's website URL (uniform resource locator) is entered into the Organization Website field 112. Additional information about the charitable organization may be asked for by the Web page form. Finally the Submit button 113 is clicked. This organization is then added to the Charitable Organization Table in the database by a program executing on the Web server in response to the submission of this form 110. This process is repeated by the website administrator until a complete list of popular charitable organizations has been entered into the database.

Next, a user, for example John Q. Public, may browse to a website that embodies the invention and choose to register to begin tracking his success at causing others to make donations to charitable organizations. This is recorded as a donation of time. John Q. Public is presented with a Web page form 120 as shown in FIG. 2. John Q. Public's name is entered into the Name field 121, an alias of John Q. Public choice is entered into the Alias field 122, a password of John Q. Public's choice is entered into the Password field 123, the Solicitor field 124 is left blank because John Q. Public was not encouraged to begin tracking his success at causing others to make donations to charitable organizations by any individual. A privacy option 125 of John Q. Public's choice is selected indicating whether John Q. Public would like to be included in a searchable directory of individuals who have registered to track their success at causing donations to be made to charitable organizations. Additional information about the user may be asked for by the Web page form 120. Finally the Submit button 126 is clicked. John Q. Public is then added to the Donation Table in the database by a program executing on the Web server.

Next, John Q. Public may choose to encourage others verbally or by other means to make donations to charitable organizations. Next, a different user who was encouraged by John Q. Public to make a donation to a charitable organization, for example Timothy Johnson, may browse to a website 130 that embodies one aspect of the invention and choose to make a donation to a charitable organization, for example to the American Red Cross. Timothy Johnson is presented with a Web page form 130 as shown in FIG. 3. Timothy Johnson's name is entered into the Donor Name field 131, an alias of Timothy Johnson's choice is entered into the Donor Alias field 132, a password of Timothy Johnson's choice is entered into the Password field 133, an amount of Timothy Johnson's choice is entered into the Donation Amount field 134, a charitable organization of Timothy Johnson's choice is entered into the Recipient Organization field 135 which contains a list of charitable organizations that were previously added to the Charitable Organization table as shown in FIG. 1, John Q. Public's alias or an alternative identifier such as the John Q. Public's Donor Identifier or John Q. Public's name is entered into the Solicitor field 136, a privacy option 137 of Timothy Johnson's choice is selected indicating whether Timothy Johnson would like to be included in a searchable directory of individuals who have registered to track their success at causing donations to be made to charitable organizations. Additional information about the donormaybe asked forbythe Web page form 130. Finally the Submit button 138 is clicked. The donation process is then continued until a donation is collected. The process of collecting a donation may be completed on the website using an electronic payment such as a credit card or a payment service such as PayPal® or Google Checkout™, or the process of collecting a donation may involve manual processes, providing for donations to be made using checks or money orders. After a donation is collected Timothy Johnson is automatically added to the Donation Table in the database.

Next, a different user, for example John Doe, may browse to a website that embodies the invention after making a verifiable donation encouraged by John Q. Public directly to a charitable organization, for example to the American Cancer Society, and choose to record that donation using the invention. John Doe is presented with a Web page form 140 as shown in FIG. 4. John Doe's name is entered into the Donor Name field 141, an alias of John Doe's choice is entered into the Donor Alias field 142, a password of John Doe's choice is entered into the Password field 143, an amount of John Doe's choice is entered into the Donation Amount field 144, a charitable organization of John Doe's choice is entered into the Recipient Organization field 145 which contains a list of charitable organizations that were previously added to the Charitable Organization table prior, John Q. Public's alias or an alternative identifier such as the John Q. Public's Donor Identifier or John Q. Public's name is entered into the Solicitor field 146, a privacy option 147 of John Doe's choice is selected indicating whether John Doe would like to be included in a searchable directory of individuals who have registered to track their success at causing donations to be made to charitable organizations. Additional information about the donor may be asked for by the Web page form 140. Finally the Submit button 148 is clicked. The donation is then verified through a manual process and John Doe is then added to the Donation Table in the database by a program executing on the Web server.

Next, a user, for example John Q. Public, may browse to a website that embodies one aspect of the present invention and choose to learn how to embed content 150 into his personal Web page 152 that is designed to report to viewers of his personal Web page the quantitative measure of success at causing donations to be made to charitable organizations that he has attained and that is designed to provide a mechanism for others to begin tracking their success at causing donations to be made to charitable organizations or to make or record a donation to a charitable organization. John Q. Public is presented with a segment of HTML (Hypertext Markup Language) code that may be embedded into a host Web page, such as his personal Web page 152, and instructions describing how to do this.

FIG. 5 shows what may be presented when the host Web page, e.g., John Q. Public's personal Web page 152, is viewed in a Web browser by a different user, for example Steve Smith. A segment of Web content 150 is embedded in his personal Web page 152. This segment of HTML code will retrieve and display John Q. Public's real time quantitative measure of success at causing others to make donations to charitable organizations 151. This segment of HTML code will also display one or more Web links 153, 155, which when clicked by Steve Smith will navigate him to a website that embodies one aspect of the invention, such as one shown in FIGS. 1-4, allowing him to register to begin tracking his success at causing others to make donations to charitable organizations, or to make or record a donation to a charitable organization of his choice, and automatically recording John Q. Public as Steve Smith's solicitor.

Next, a user, for example James Campbell, may browse to a website that embodies one aspect of the invention and choose to search a directory of individuals who have registered to track their success at causing donations to be made to charitable organizations. James Campbell is presented with a Web page form 160 as shown in FIG. 6. John Q. Public's alias or an alternative identifier such as the John Q. Public's Donor Identifier or John Q. Public's name is entered into the Search Criteria field 161. Additional search criteria fields may be provided by the Web page form 160. Finally, the Submit button 162 is clicked. A query is run against the Donation table in the database by a program executing on the Web server, and James Campbell is presented with the Web page 170 shown in FIG. 7. The search results include the alias 171 of individuals matching the search criteria who have registered to track their success at causing donations to be made to charitable organizations. The search results further include the real time quantitative measure of success at causing others to make donations to charitable organizations 172 of each individual included in the search results. The search results further include one or more Web links 173, which when clicked by James Campbell will navigate him to a Web page that will allow him to register to begin tracking his success at causing others to make donations to charitable organizations, or to make or record a donation to a charitable organization of his choice, and automatically recording John Q. Public as James Campbell's solicitor. Although it is not preferred for privacy reasons, the search results may include additional information about individuals matching the search criteria who have registered to track their success at causing donations to be made to charitable organizations, such as contact information or anything else stored in the database.

Table 3 shows an exemplary database table based upon the Charitable Organizations Table defined above, with data representing a list of three popular charitable organizations. As organizations are added to this table, a unique identifier is automatically assigned to each record. This can be done by incrementing a counter.

TABLE 3
Charitable Organization Table

| Organization | | |
|---|---|---|
| Identifier | Organization Name | Organization Website |
| 1 | American Red Cross | http://www.redcross.org |
| 2 | American Cancer Society | http://www.cancer.org |
| 3 | American Heart | http://www.americanheart.org |
| | Association | |

FIG. 8 shows one embodiment of a database table 210 based upon the Donation Table defined in Table 2, with exemplary data representing ten hypothetical donations, e.g., donation identifiers 1-10. As donations of time or money are added to this table, a unique identifier is automatically assigned to each record. This can be done by incrementing a counter. Additionally, left and right position indicators are derived following the addition of a new donation node to a donation hierarchy, and then assigned to the record to indicate where this donation resides in the hierarchy.

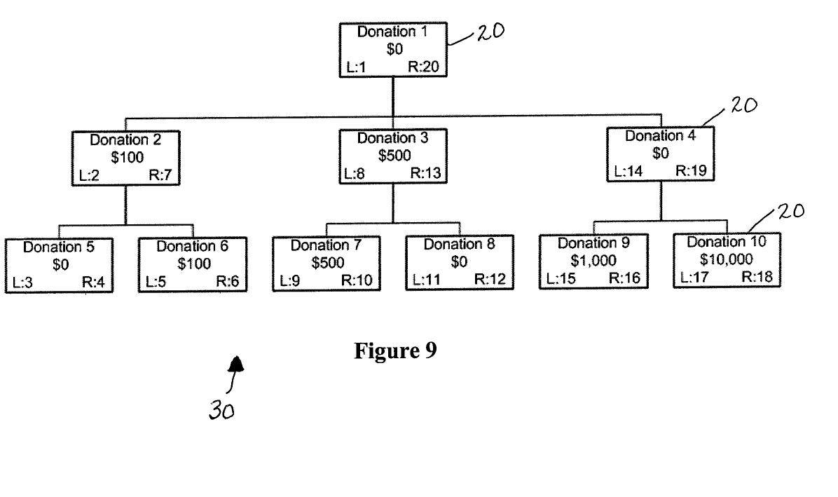

FIG. 9 graphically shows the hierarchy 30 that is represented by the hypothetical donation data illustrated in FIG. 8. As donations of time or money are made, nodes 20 representing the donations are placed in a hierarchy as a child of, i.e., immediately beneath, the node representing the donation of time or money made by the solicitor who encouraged the current donor to make a donation, and as a sibling to, i.e., immediately to the right of, any other nodes representing donations of time or money that were made at the encouragement of the same solicitor.

After the new node is placed in the hierarchy, all position values equal to or greater than the value of the parent node's right position are incremented by two in order to create space for the new node. Next, the value of the new node's left position is derived by subtracting two from the value of its parent's right position, and the value of the new node's right position is derived by subtracting one from the value of its parent's right position.

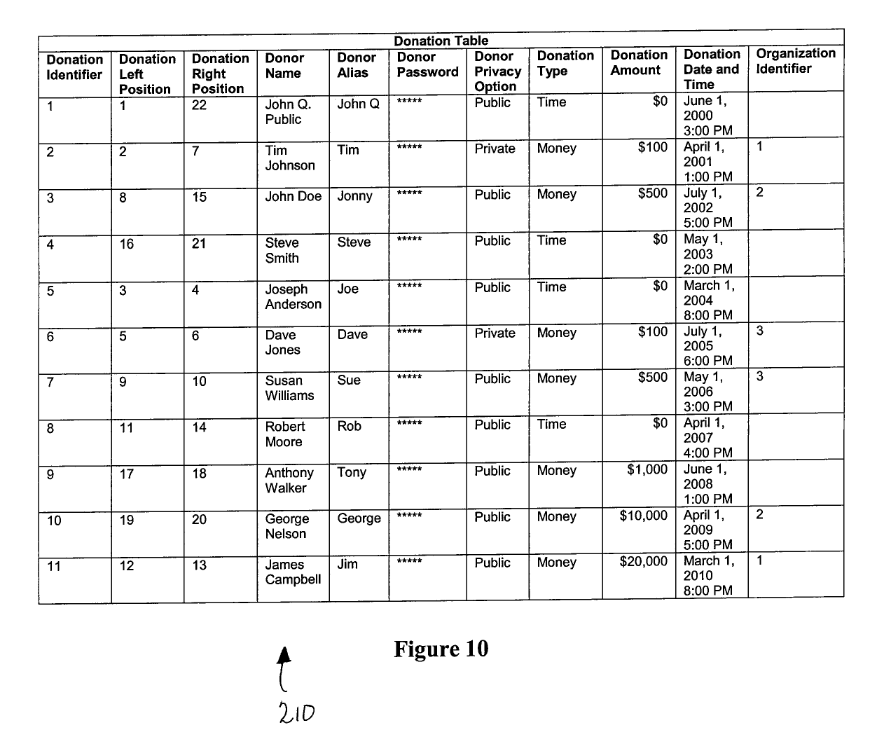

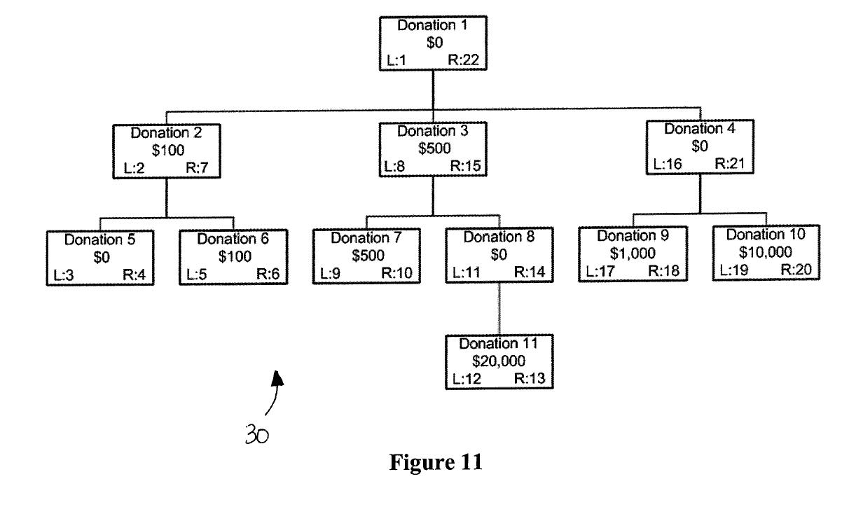

FIG. 10 shows the database table 210 illustrated in FIG. 8, augmented with an additional donation. The donation given donation identifier 11 was made by James Campbell at the encouragement of Robert Moore, whose donation of time is represented by donation identifier 8. Therefore the donation identifier 11 is placed in the hierarchy 30 immediately beneath donation identifier 8. Next, all position values equal to or greater than the value twelve (this being the value of the right position of donation identifier 8) are incremented by two. Finally, the value of the new node's left position is derived by subtracting two from the value of its parent's new right position of fourteen, and the value of the new node's right position is derived by subtracting one from the value of its parent's new right position of fourteen. Therefore the value of the left position of donation identifier 11 is twelve and the value of the right position of donation identifier 11 is thirteen. FIG. 11 shows the hierarchy 30 that is represented by the hypothetical donation data illustrated in FIG. 10.

Using the data in the database table 210 illustrated in FIG. 10, it is possible to derive the quantitative measure of success at causing donations to be made to charitable organizations for any given individual who made a donation of time or money that was recorded in the database table illustrated in FIG. 10 using the following formula: the measure of success for a given individual is equal to the sum of the value in the Donation Amount field of all donation records in the database table with a left position equal to or greater than the left position of the donation made by that individual, and with a right position equal to or less than the right position of the donation made by that individual.

As an example, using the data in the database table 210 illustrated in FIG. 10 to derive John Q. Public's quantitative measure of success at causing donations to be made to charitable organizations, the Donation Amount field of all donation records in the database table with a left position equal to or greater than one (the value of the left position of Donation 1, made by John Q. Public), and with a right position equal to or less than twenty two (the value of the right position of Donation 1, made by John Q. Public) are summed. All records shown in FIG. 10 meet these criteria. The sum of the Donation Amount field of all donation records shown in FIG. 10 is $32,200. Though no monetary donations to charitable organizations were made by John Q. Public, his quantitative measure of success at causing donations to be made to charitable organizations is calculated to be $32,200.

Alternatively, the entity identified as donation identifier 1 could be a charitable organization such that there is only one hierarchy with only one top node and the charitable organization is the only entity without a solicitor. Under this scenario, if all registered individuals are arranged into one large hierarchy, then all the donations may be summed to create one ultimate score for the implementer of the system, i.e., the charitable organization. Under this scenario, unsolicited donations would be placed hierarchically beneath the top node representing the charitable organization, essentially listing that organization as the solicitor of individuals who do not designate a solicitor.

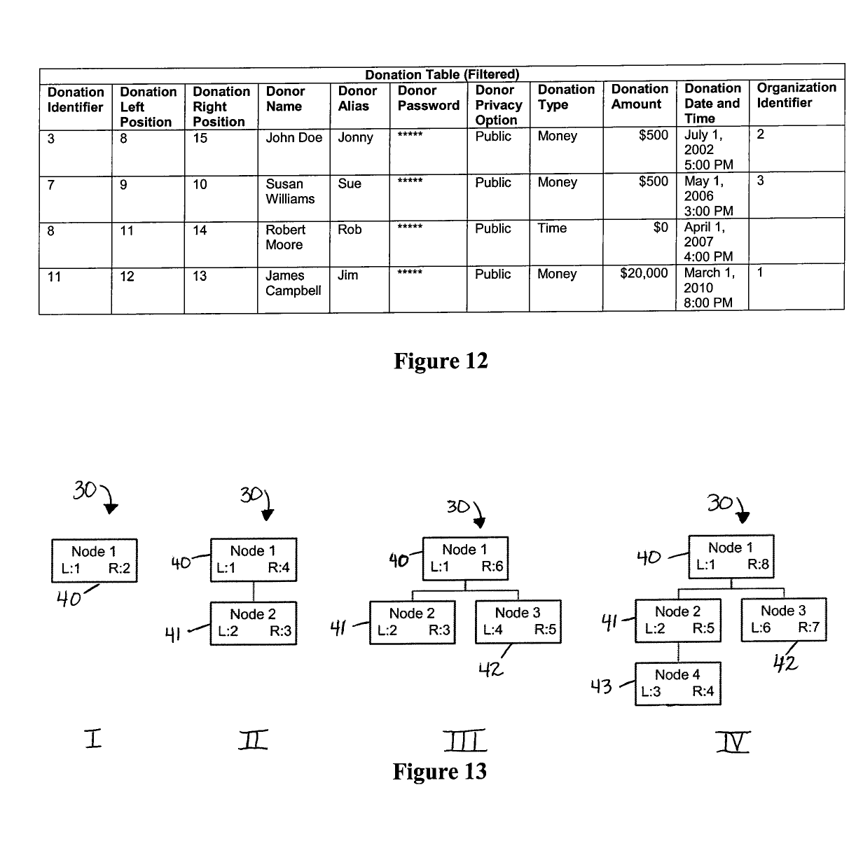

As another example, using the data in the database table illustrated in FIG. 10 to derive John Doe's quantitative measure of success at causing donations to be made to charitable organizations, the Donation Amount field of all donation records in the database table with a left position equal to or greater than eight (the value of the left position of Donation 3, made by John Doe), and with a right position equal to or less than fifteen (the value of the right position of Donation 3, made by John Doe) are summed. FIG. 12 shows only the records from FIG. 10 which meet these criteria. The sum of the Donation Amount field of all donation records shown in FIG. 15 is $21,000. Though a donation of $500 is the only donation made by John Doe, his quantitative measure of success at causing donations to be made to charitable organizations is calculated to be $21,000.

Any user who has registered to track his/her success at causing donations to be made to charitable organizations may use his/her password to gain access to the website that embodies the invention to see and report detailing his/her current quantitative measure of success at causing donations to be made to charitable organizations, or to see reports detailing donation totals broken down by recipient organization and/or by time-frame (e.g. daily totals, weekly totals, monthly totals, annual totals, year-to-date totals, or lifetime totals). Reports such as these may also be delivered automatically by the system in electronic or paper form to individuals registered to track their success at causing donations to be made to charitable organizations, or to individuals who have requested them.

Another embodiment of the invention may provide an individual with Web content that may be embedded in their personal Web page, containing one or more Web links for others to click, designed to provide a mechanism for others to begin tracking their success at causing donations to be made to charitable organizations or to make or record a donation to a charitable organization. When clicked, a Web link will navigate others to a website that embodies the invention, allowing them to register to begin tracking their success at causing others to make donations to charitable organizations, or to make or record a donation to a charitable organization of their choice, and automatically recording the individual that embedded this Web content into his/her personal Web page as the solicitor. This section of Web content may also be embedded in an HTML based email message.

Yet another embodiment of the invention may provide an individual registered to track their success at causing donations to be made to charitable organizations with a mechanism to send a text- or HTML-based email message to another individual containing Web content designed to report the quantitative measure of success at causing donations to be made to charitable organizations that the individual sending the message has attained, and to provide a mechanism for others to begin tracking their success at causing donations to be made to charitable organizations or to make or record a donation to a charitable organization. This message may contain information identifying the individual who sent the message for use in recording who the solicitor was. This message may contain information such as account credentials including a temporary password that may be used to login to a website that embodies the invention to begin tracking their success at causing donations to be made to charitable organizations or to make or record a donation to a charitable organization.

Another embodiment of the invention may provide an individual registered to track their success at causing donations to be made to charitable organizations with a mechanism to print a paper form that may be sent to another individual to provide them with the information they need to use a website that embodies the invention to begin tracking their success at causing donations to be made to charitable organizations or to make or record a donation to a charitable organization. This paper form may contain information identifying the individual that printed it for use in determining the solicitor. This paper form may contain information about the quantitative measure of success at causing donations to be made to charitable organizations that the individual who printed the paper form has attained. This paper form may contain information such as account credentials including a temporary password that may be used by the recipient of the paper form to login to a website that embodies the invention to begin tracking their success at causing donations to be made to charitable organizations or to make or record a donation to a charitable organization.

Another embodiment of the invention may provide an individual registered to track their success at causing donations to be made to charitable organizations with a mechanism to store and share with others a list of his/her preferred charities.

Another embodiment of the invention may provide individuals registered to track their success at causing donations to be made to charitable organizations with a mechanism to upload an image file that they would like shown adjacent to their name or alias.

Another embodiment of the invention may provide authorized representatives of a registered charitable organization with a mechanism to login to a website that embodies the invention and record information about a donation to their organization. Further, this authorized representative may be provided with a mechanism to print a paper form that may be sent to the donor to provide them with the information they need to use a website that embodies the invention to begin tracking their success at causing donations to be made to charitable organizations. Further, this authorized representative may be provided with a mechanism to send a text- or HTML-based email message to the donor to provide them with the information they need to use a website that embodies the invention to begin tracking their success at causing donations to be made to charitable organizations. Further, the paper form or electronic message may contain information such as account credentials including a temporary password that may be used by the donor to login to the website that embodies the invention to begin tracking their success at causing donations to be made to charitable organizations or to make or record additional donations to a charitable organization.

Another embodiment of the invention may include the use of one or more electronic forms that are part of a computer program, other than a Web browser, running on a personal desktop, laptop, or handheld computer, or other electronic device, and designed to perform the same functions that may be performed using a Web browser as described herein.

Another embodiment of the invention may include the use of one or more paper forms designed to perform the same functions that may be performed using a Web browser as described herein. Yet another embodiment of the invention may include the use of one or more Web services, designed to perform the same functions that may be performed using a Web browser as described herein. For example, a Web service may collect the information shown in FIGS. 1-4, a Web service may provide information about the quantitative measure of success at causing donations to be made to charitable organizations that a particular individual has attained. Further, for example, a Web service may provide the ability to search the directory of individuals who have registered to track their success at causing donations to be made to charitable organizations.

Another embodiment of the invention may include the use of one or more customer service representatives who, on behalf of another person, in response to a written or verbal request, perform the same functions that may be performed using a Web browser as described herein. For example, one or more customer service representatives, in response to a written or verbal request, may provide information about the quantitative measure of success at causing donations to be made to charitable organizations that a particular individual has attained. Although it is not preferred for privacy reasons, the customer service representative may provide other information about the individual, such as contact information or anything else stored in the database. Further, for example, one or more customer service representatives, in response to a written or verbal request, may perform a search of the directory of individuals who have registered to track their success at causing donations to be made to charitable organizations. The customer service representative may provide a person, verbally or in writing (on paper or in electronic format), with the results of the search, which may include information similar to that shown in FIG. 7. Although it is not preferred for privacy reasons, the search results may also include other information about the individuals that match the search criteria, such as contact information or anything else stored in the database.

Another embodiment of the invention may similarly facilitate and track donations, and report via the Internet and other media an individual's quantitative measure of success at causing donations to be made to non-profit organizations that are not charitable organizations.

The description set out above is merely of exemplary preferred embodiments of the invention, and it is contemplated that numerous additions and modifications can be made. These examples should not be construed as describing the only possible embodiments of the invention, and the true scope of the invention will be defined by the claims included in any later-filed utility patent application claiming priority from this provisional patent application.

It is recognized that the system and method according to preferred embodiments of the present invention may be used in connection with a wide variety of entities, and is not limited to charitable organizations. For example, preferred embodiments of the present invention may be used by non-profit organizations, including political organizations and other similarly situated entities.

In addition, it should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

Although the preferred embodiments have been described, it should be understood that various changes, substitutions, and alterations can be made herein without departing from the scope of the present invention. For example, although the present invention has been described and illustrated primarily in relation to Internet accessible Web applications, it should be understood that the present invention is in no way limited to only the Internet or Web and may be implemented on other networks also. It should be understood that the application of the present invention is not limited only to charitable fundraising. Rather, the present invention can be implemented to track the success of individuals soliciting donations to non-profit organizations that are not charities, including but not limited to non-profit political organizations. Furthermore, it should be noted that the present invention can be implemented using virtually any computer system or other networking system and virtually any available programming language.

I claim:

1. A system for tracking the success of an individual in causing donations to be made to non-profit organizations, comprising:
a list comprised of at least one organization;
a list of registered donors arranged in a hierarchy; wherein each donor descends from an associated solicitor;
a means for registering new donors including means for selecting an already registered donor as a solicitor;
a means for recording donations; and
a means for scoring an individual donor by summing the value of donations made by that donor with the value of donations made by all donors in the hierarchy that descend from the individual donor.

2. The system of claim 1, wherein the means for registering new donors includes at least one of: means to identify the solicitor via a unique identifier, means for searching and selecting a registered solicitor, and means for registering an unregistered solicitor.

3. The system of claim 2 implemented in a computer program language that is compatible with at least one computer operating system.

4. The system of claim 1, wherein donors may display a personnel identifier selected from at least one of: an alias and a proper name.

5. The system of claim 4, wherein an anonymous alias may be selected.

6. The system of claim 1, further comprising means for adding to the list of organizations.

7. A system for quantitatively measuring and reporting the success of an individual in causing donations to be made to non-profit organizations, comprising,
a list comprising at least one non-profit organization;
a means for registering potential donors including the means to select a solicitor;
a database of registered donors arranged in a hierarchy such that donors descends from their associated solicitors;
a means for recording donations;
a means for scoring an individual donor by summing value of donations made by the individual donor with the value of donations made by all donors in the hierarchy that descend from the individual donor; and
a means for reporting the individual donor's score.

8. The system of claim 7, wherein the means for reporting the score of an individual donor is at least one of: a personal web page and an email message.

9. The system of claim 7, wherein the means for reporting the score of an individual donor is at least one of: a web service and a person serving in a customer service role.

10. The system of claim 8, wherein the at least one of web page and email contain embedded web content.

11. The system of claim 10, wherein the embedded web content includes means for displaying the individual donor's score.

12. The system of claim 11, wherein the embedded web content includes a click-through link that can be used as an entry point for potential donors to the system, wherein the system will implicitly record the solicitor.

13. The system of claim 7, wherein each registered donor in the database is assigned at least one number to represent their position in the hierarchical structure.

14. A method for quantitatively measuring the personal success of an individual in causing donations to be made to non-profit organizations, comprising:
providing a list of non-profit organizations;
registering donors; wherein the names of donors are stored in database arranged in a hierarchy such that new donors descend directly from a solicitor, if one has been identified, and wherein if the new donors are themselves solicitors for additional donors, the additional donors descend directly from the new donors;
recording a donation;
scoring each donor by summing the value of donations made by a donor with the donations made by all donors in the hierarchy that descend from that donor.

15. The method of claim 14, further comprising the steps of:
providing a searchable directory of registered donors; and
providing a mechanism to encourage potential donors to participate in measuring their personal success in causing donations to be made to non-profit organizations.

16. The method of claim 15, wherein the mechanism to encourage potential donors includes a website displaying a donor's score.

17. The method of claim 16, wherein the each score or related web content displayed on the website is a web link such that clicking on the web link enables an individual to register to be scored on their success at making and causing to be made donations to non-profit organizations and wherein the person whose web link was clicked is designated as a solicitor of the individual who registered.

18. The method of claim 17, wherein
an individual clicking on the web-link of a registered donor and registering themselves to be scored places the individual below the registered donor in the hierarchical structure.

19. The method of claim 15, wherein the mechanism for encouraging additional individuals to participate is a section of web content embedded in an HTML-based email message.

20. The method of claim 14, further comprising:
in response to a user request, communicating the quantitative measure of success at causing donations to be made to non-profit organizations.
